(19) United States
(12) Patent Application Publication
(10) Pub. No.: US 2010/0037801 A1
(43) Pub. Date: Feb. 18, 2010

(54) Process for Producing Elongated-Shaped Silica Sol

(75) Inventors: Yutaka Ohmori, Sodegaura-shi (JP); Hirotomo Itou, Koriyama-shi (JP); Kenji Yamaguchi, Sodegaura-shi (JP)

Correspondence Address: OLIFF & BERRIDGE, PLC, P.O. BOX 320850, ALEXANDRIA, VA, 22320-4850, US

(73) Assignee: Nissan Chemical Industries, Ltd., Tokyo (JP)

(21) Appl. No.: 12/449,214

(22) PCT Filed: Feb. 1, 2007
(86) PCT No.: PCT/JP2007/051697

§ 371 Date: Jul. 29, 2009

(51) Int. Cl. C04B 14/04

(52) U.S. Cl. 106/482

(57) ABSTRACT

There is provided a method for producing an elongated-shaped silica sol comprising the following steps:
(a) adding an aqueous solution containing a water soluble Ca salt and/or Mg salt to an aqueous colloidal solution of active silicic acid with an SiO₂ concentration of 1 to 6% by mass and a pH of 2 to 5 in a mass ratio of CaO and/or MgO to SiO₂ in the active silicic acid of 1500 to 15,000 ppm, and mixing;
(b) adding alkali metal hydroxide, a water soluble organic base, or water soluble silicate thereof to an aqueous solution obtained through (a) in a determined molar ratio to SiO₂, and mixing;
(c) heating a mixture obtained through (b) at 85 to 200° C. for 0.5 to 20 hours so as to obtain a colloidal solution;
(d) removing, from the colloidal solution obtained through (c), part of water and at least part of anions derived from the aqueous solution containing the water soluble Ca salt and/or Mg salt; and
(e) heating a colloidal solution obtained through (d) at a temperature of 80 to 195° C. that is lower than a heating temperature in (c) for 0.5 to 20 hours.

### TECHNICAL FIELD

The present invention relates to a process for producing an elongated-shaped silica sol. More specifically, the silica sol produced by this production process is characterized by the shape of colloidal silica particles. A silica sol obtained shows an excellent coating property due to the shape when being dried on a solid surface, is used for a pigment and in other various fields. The present invention provides a process for efficiently producing the silica sol.

### BACKGROUND ART

As a process for producing an elongated-shaped silica sol, the following method is disclosed. To an aqueous colloidal solution of active silicic acid with a silicon dioxide (SiO₂) concentration of 1 to 6% by mass, an aqueous solution containing a water soluble calcium salt, magnesium salt, or the mixture thereof is added in a mass ratio of calcium oxide (CaO), magnesium oxide (MgO), or the both to silica (SiO₂) in active silicic acid of 1500 to 8500 ppm. Furthermore, to the resultant solution, alkali metal hydroxide, an organic base, or a silicate of an aqueous solution of the alkali metal hydroxide and the organic base is added to be a molar ratio converted using a formula represented by SiO₂/M₂O (where SiO₂ represents a total content of a silica content derived from the active silicic acid and a silica content in the water soluble silicate, and M represents the alkali metal atom or the organic base molecule) of 20 to 300, followed by heating at 60 to 300° C. for 0.5 to 40 hours (see Patent Document 1).

The shapes of colloidal silica particles that constitute the elongated-shaped silica sol can be observed on a photograph taken by using an electron microscope. Although the shapes are not unified, numerous colloidal silica particles in the sol have commonly long and thin shapes. These numerous colloidal silica particles are roughly divided into 4 types: almost straight particles, bent particles, branched particles, and particles with rings. Bent and branched particles constitute a majority. When particles are seen one by one, a particle has an almost uniform thickness from one end to the other end. The dimensions of such elongated-shaped colloidal silica particles are not appropriately expressed as a length estimated on an electron micrograph, and is appropriately expressed as a measurement obtained by dynamic light scattering that enables to measure a particle size corresponding to a length. Such obtained particle thickness can be expressed as an equivalent to a diameter of spherical colloidal silica that has a specific surface area similar to a specific area of the particle as determined by a standard nitrogen adsorption method (Brunauer-Emmett-Teller (BET) method).

Patent Document 1: Japanese Patent Application Publication No. JP-A-1-317115 (claims)

### DISCLOSURE OF THE INVENTION

### Problem to be Solved by the Invention

Although, typically, a sol consisting of spherical colloidal silica is highly stable and used for various purposes, when, for example, a film is made from a composition containing this silica sol, cracking easily occurs on the film depending on a particle shape that renders this preferable dispersibility. In addition, when a composition containing this silica sol and ceramic fibers is dried, a shift of colloidal silica to the surface of the composition occurs, which causes practical problems such as dust on the surface of the dried matter.

An elongated-shaped silica sol allows these practical problems to be improved, shows an excellent coating property when being dried on a solid surface, and, therefore, can be used well for a pigment and in other various fields.

Although the elongated-shaped silica sol can be obtained using a method described in Patent Document 1, this method allows, because of heating, simultaneous growth of a particle diameter (D_{L} nm) determined by the dynamic light scattering and a particle diameter (D_{B} nm) determined by a nitrogen adsorption method; therefore, both of the particle diameter D_{L} and the particle diameter D_{B} are difficult to be controlled.

The present invention provides a method for producing a stable elongated-shaped silica sol efficiently by controlling both of the particle diameter D_{L} and the particle diameter D_{B} in a method for producing the elongated-shaped silica sol.

### Means for Solving the Problem

The present invention is a method for producing an elongated-shaped silica sol including the following (a), (b), (c), (d), and (e); wherein a particle diameter (D_{B2} nm) of colloidal silica particles obtained through (e) determined by a nitrogen adsorption method is 5 to 20 nm, a ratio of particle diameters (D_{L2}/D_{B2}) of the particle diameter (D_{B2} nm) and a particle diameter (D_{L2} nm) of the colloidal silica particles determined by dynamic light scattering is 4 to 20, and a particle diameter (D_{B1} nm) of colloidal silica particles obtained through (c) determined by the nitrogen adsorption method and a particle diameter (D_{L1} nm) of colloidal silica particles obtained through (c) determined by the dynamic light scattering as well as the particle diameter (D_{B2} nm) of colloidal silica particles obtained through (e) determined by the nitrogen adsorption method, and the particle diameter (D_{L2} nm) of colloidal silica particles obtained through (e) determined by the dynamic light scattering satisfy the relationship represented by the following formula (I):

(D_{L2}/D_{B2})/(D_{L1}/D_{B1})≧1.2 (I);

(a) adding an aqueous solution containing a water soluble calcium salt, magnesium salt, or a mixture of the water soluble calcium salt and magnesium salt to an aqueous colloidal solution of active silicic acid with an SiO₂ concentration of 1 to 6% by mass and a pH of 2 to 5 in a mass ratio of CaO, MgO, or both of CaO and MgO to SiO₂ in the active silicic acid of 1500 to 15,000 ppm, and mixing;

(b) adding alkali metal hydroxide, a water soluble organic base, or water soluble silicate of the alkali metal hydroxide or the water soluble organic base to an aqueous solution obtained through (a) in a molar ratio converted by a formula represented by SiO₂/M₂O (where SiO₂ represents a total content of a silica content derived from the active silicic acid and a silica content in the water soluble silicate, and M represents the alkali metal atom or the organic base molecule) of 20 to 200, and mixing;

(c) heating a mixture obtained through (b) at 85 to 200° C. for 0.5 to 20 hours so as to obtain a colloidal solution;

(d) removing, from the colloidal solution obtained through (c), part of water and at least part of anions derived from the aqueous solution containing the water soluble calcium salt, magnesium salt, or the mixture of the water soluble calcium salt and magnesium salt; and

(e) heating a colloidal solution obtained through (d) at a temperature of 80 to 195° C. that is lower than a heating temperature in (c) for 0.5 to 20 hours.

Preferable modes are described as follows.

Heating in (e) is performed at a temperature lower by 5 to 60° C. than the heating temperature in (c).

Removal of anions in (d) is performed until the amount of anions in the colloidal solution becomes 1.0% by mass or less to the amount of SiO₂ contained in the colloidal solution.

Removal of water in (d) is performed until the concentration of SiO₂ in the colloidal solution becomes 10 to 40% by mass.

Measurement of a particle diameter (D_{L}) determined by the dynamic light scattering in the present invention is described in Journal of Chemical Physics, vol. 57, No. 11 (December, 1972), p. 4814, and can easily be done, for example, using a commercially available device called N4 (manufactured by Beckman Coulter, Inc., USA). Measurement of a particle diameter (D_{B} nm) determined by a nitrogen adsorption method can be calculated using the following formula (II):

D_{B}(nm)=2720/S (m²/g) (II)

with a specific surface area S determined by a standard BET method.

### EFFECTS OF THE INVENTION

The present invention can easily control both of a particle diameter D_{L} and a particle diameter D_{B} through two processes including (c) that mainly controls the particle diameter D_{B} and (e) that mainly controls the particle diameter D_{L} in producing an elongated-shaped silica sol.

The method of the present invention provides an elongated-shaped silica sol in which colloidal silica particles are dispersed stably in a liquid medium. In the colloidal silica particles, a particle diameter (D_{B2} nm) of colloidal silica particles obtained through (e) determined by a nitrogen adsorption method is 5 to 20 nm. The ratio (D_{L2}/D_{B2}) of the particle diameter (D_{B2} nm) and a particle diameter (D_{L2} nm) of colloidal silica particles determined by the dynamic light scattering is 4 to 20. In addition, a particle diameter (D_{B1} nm) of colloidal silica particles obtained through (c) determined by the nitrogen adsorption method and a particle diameter (D_{L1} nm) of colloidal silica particles obtained through (c) determined by the dynamic light scattering, the particle diameter (D_{B2} nm) of colloidal silica particles obtained through (e) determined by the nitrogen adsorption method, and the particle diameter (D_{L2} nm) of colloidal silica particles obtained through (e) determined by the dynamic light scattering satisfy the relationship represented by the following formula (I):

(D_{L2}/D_{B2})/(D_{L1}/D_{B1})≧1.2 (I).

(D_{L2}/D_{B2}) and (D_{L1}/D_{B1}) represent the elongation of elongated-shaped colloidal silica. As a ratio of (D_{L2}/D_{B2})/(D_{L1}/D_{B1}) is increased, the colloidal silica particles become longer and thinner.

The elongated-shaped silica sol obtained by the method of the present invention shows an excellent coating property when being dried on a solid surface, so that the silica sol can be used for a pigment and in other various fields.

### BEST MODES FOR CARRYING OUT THE INVENTION

Hereinafter, the present invention will be described in detail.

An aqueous colloidal solution of active silicic acid used in (a) is an aqueous solution in which silicic acid and polymer particles of silicic acid with a particle diameter of less than 3 nm coexist, can easily be obtained by a well-known method. A preferable aqueous colloidal solution of active silicic acid can be obtained by subjecting a water soluble silicate, for example, a diluted aqueous solution of water glass that has a molar ratio converted using a formula represented by SiO₂/M₂O (where SiO₂ represents a total content of a silica content derived from the active silicic acid and a silica content in the water soluble silicate, and M represents the alkali metal atom or the organic base molecule) of about 1 to 4.5 to a cation exchange treatment. In addition, the aqueous colloidal solution of active silicic acid contains SiO₂, generally, at 6% by mass or less, preferably, at 1 to 6% by mass, and is used at a pH of 5 or less, preferably 2 to 5. The pH of an aqueous colloidal solution of active silicic acid can easily be adjusted by leaving part of cations during the cation exchange treatment of the water glass aqueous solution or by adding a small amount of alkali metal hydroxide, a water soluble organic base, or the like to an aqueous colloidal solution of active silicic acid obtained after removal of all or part of the cations. Since the aqueous colloidal solution of active silicic acid is unstable and has a property of easy gelation, the aqueous colloidal solution containing few impurities that accelerate gelation is preferred and the aqueous colloidal solution immediately after the preparation is more preferred. A further preferable aqueous colloidal solution of active silicic acid can be obtained by passing an aqueous solution obtained by diluting sodium water glass that is a commercially available industrial product with water in a molar ratio of SiO₂/Na₂O of about 2 to 4 through a hydrogen-type cation exchange resin layer. As long as a sol, which is an object of the present invention, can be obtained, this aqueous colloidal solution of active silicic acid may contain other components as well as a small amount of cations, anions, etc.

In (a), a water soluble calcium salt, magnesium salt, or the mixture of the water soluble calcium salt and magnesium salt, preferably, as an aqueous solution thereof, is added to this aqueous colloidal solution of active silicic acid.

An added amount of a calcium salt, magnesium salt, or the mixture of the calcium salt and magnesium salt is an amount in which a mass ratio of CaO, MgO, or both of CaO and MgO to SiO₂ in the above aqueous colloidal solution of active silicic acid is 1500 to 15,000 ppm. The addition is preferably performed with stirring, and there is no particular limitation on the temperature of an aqueous colloidal solution during the addition and a duration required for the addition. The temperature may be about 2 to 50° C. and the duration of the addition may be about 5 to 30 minutes. An example of a calcium salt or a magnesium salt includes inorganic salts and organic salts such as chloride, nitrate, sulfate, sulfamate, formate, and acetate of calcium or magnesium. These calcium salt and magnesium salt can be used alone or as a mixture thereof. A concentration of an aqueous solution of these salts may be, but not particularly limited to, about 2 to 20% by mass. A sol can be more preferably produced when multivalent metal components other than calcium and magnesium are contained in an aqueous colloidal solution of the above active silicic acid in addition to such calcium salts and magnesium salts. Examples of multivalent metals other than calcium and magnesium include bivalent, trivalent, or quadrivalent metals such as strontium (Sr), barium (Ba), zinc (Zn), tin (Sn), aluminum (Al), lead (Pb), copper (Cu), iron (Fe), nickel (Ni), cobalt (Co), manganese (Mn), chrome (Cr), yttrium (Y), titanium (Ti), and zirconium (Zr). An amount of these multivalent metal components is preferably about 10 to 80% by mass relative to an amount of CaO, MgO, etc. when an amount of a calcium salt or a magnesium salt added in (a) is converted into an amount of CaO, MgO, etc.

If the above multivalent metal contents remain in an aqueous colloidal solution of active silicic acid obtained through the cation exchange treatment of the diluted solution of water glass, this multivalent metal content is, after the conversion into oxide, included as part of the above concentration of 10 to 80% by mass. Residual multivalent metal contents are preferably added to an aqueous colloidal solution of active silicic acid together with a calcium salt or a magnesium salt as water soluble salts of the above multivalent metals. Preferable examples of the multivalent metals include inorganic acid salts and organic acid salts such as chloride, nitrate, sulfate, sulfamate, formate, and acetate. In addition, other salts, for example zincate, stannate, aluminate, plumbate, such as sodium aluminate and sodium stannate can be added.

The calcium salt, the magnesium salt, the other multivalent metals, and the like that are preferably mixed homogenously with an aqueous colloidal solution of active silicic acid, are usually added as an aqueous solution.

In (b), alkali metal hydroxide, a water soluble organic base, or water soluble silicate of the alkali metal hydroxide and the water soluble organic base is added to the aqueous colloidal solution obtained through (a). This addition is preferably performed as soon as possible after the termination of (a) with stirring. In addition, there is no particular limitation on the temperature of an aqueous colloidal solution during this addition and the duration required for the addition. For example, the temperature may be about 2 to 50° C. and the duration of the addition may be about 5 to 30 minutes. Alkali metal hydroxide, a water soluble organic base, or water soluble silicate of the alkali metal hydroxide and the water soluble organic base is preferably mixed homogenously with an aqueous solution obtained through (a), is added directly or as an aqueous solution. The alkali metal hydroxide includes, for example, hydroxides of sodium, potassium, and lithium. The organic base includes, for example, quaternary ammonium hydroxides such as tetraethanol ammonium hydroxide, monomethyl triethanol ammonium hydroxide, and tetramethylammonium hydroxide; amines such as monoethanolamine, diethanolamine, triethanol amine, N,N-dimethylethanolamine, N-(β-aminomethyl)ethanolamine, N-methylethanolamine, monopropanolamine, and morpholine; and other basic nitrogen atom-containing organic compounds. Examples of water soluble silicate of them include sodium silicate, potassium silicate, silicate of the above quaternary ammonium hydroxides, and silicate of the above amines. Also, aluminate, stannate, zincate, and plumbate of alkali metals or organic bases can be used. These alkali metal hydroxide, organic base, silicate, metallate can be mixed with each other.

When an alkali metal atom of the above alkali metal hydroxide or a molecule of the organic base is expressed as M, an amount of alkali metal hydroxide, an organic base, or a water soluble silicate of the alkali metal hydroxide and the organic base to be added is an amount that is in a molar ratio converted using a formula represented by SiO₂/M₂O (where SiO₂ represents a total content of a silica content derived from the above active silicic acid and a silica content in the above water soluble silicate) of 20 to 300, preferably 60 to 100 mol. By this addition, the aqueous colloidal solution shows a pH of about 7 to 10.

In (c), the mixture obtained through (b) is heated. This heating is performed at 85 to 200° C., appropriately at 85 to 150° C. when an aqueous colloidal solution of active silicic acid used in (a) shows pH 2 to 4. The temperature is allowable up to 200° C. when an aqueous colloidal solution of active silicic acid used in (a) shows pH 4 to 5. About 0.5 to 20 hours are required for the time of heating. This heating is preferably performed while the above mixture is stirred and under conditions in which water evaporation does not occur, if possible. The above heating in (c) generates elongated-shaped colloidal silica particles with a particle dimension (D_{B1} nm) determined by a nitrogen adsorption method and a particle dimension (D_{L1} nm) determined by the dynamic light scattering in the mixture.

In (d), it is necessary to remove part of water from the silica sol obtained through (c) as well as to remove at least part of anions derived from an aqueous solution containing a water soluble calcium salt, magnesium salt, or the mixture of the water soluble calcium salt and magnesium salt. When the concentration of SiO₂ in the silica sol is the same as or lower than that in (c), contact among the particles does not easily occur in (e) in which the heating temperature is lower than that in (c), leading to least or no growth of a particle diameter D_{L}. Therefore, part of water is needed to be removed from the silica sol to increase a SiO₂ concentration in (d). However, excessive removal of water in (d) may cause marked contact and binding among particles by heating in (e). Thus, the reaction is difficult to be controlled, which may cause gelation of the silica sol. Therefore, a SiO₂ concentration in the silica sol obtained through (d) is 10 to 40% by mass, preferably 15 to 30% by mass.

As for an amount of anions in the silica sol obtained through (d), a mass ratio of the anions to SiO₂ that is the same as or higher than that in (c) causes marked contact and binding among colloidal silica particles by the heating in (e) so that the reaction is difficult to be controlled, which causes gelation. Thus, it is difficult to obtain a stable silica sol. Therefore, at least part of anions should be removed from the silica sol in (d). As for removal of anions, anions contained in the silica sol obtained through (c) may be removed partially or totally. Accordingly, an amount of anions in the silica sol used in (e) is 1.0% by mass or less relative to an amount of SiO₂ contained in a colloidal solution, preferably 0.01 to 0.8% by mass relative to an amount of SiO₂ contained in a colloidal solution.

There is no particular limitation on a method for removing at least part of water and anions from the silica sol in (d). Partial removal of water and anions may be performed at the same time or separately. For separate removal, either may be first. The method for removing part of water includes ultrafiltration and evaporation under reduced pressure or normal pressure. The method for removing at least part of anions includes ion exchange and ultrafiltration. The method using ultrafiltration is preferred because part of water and anions can be removed at the same time.

The mass ratio of CaO, MgO, or both of CaO and MgO to SiO₂ in the silica sol obtained through (d) is desired to be almost the same as the mass ratio of additives in (a). Excessive removal of CaO, MgO, or both of CaO and MgO causes less binding among colloidal silica particles even if the particles contact one another in (e), leading to limited growth of a particle diameter D_{L}. A method such as ultrafiltration, evaporation, or anion exchange that is used for removing at least part of water and anions in (d) does not remove CaO or MgO in a silica sol.

In (e), the silica sol obtained through (d) is heated at 80 to 195° C., preferably 90 to 190° C., as well as at the temperature lower than the heating temperature in (c) preferably by 5 to 60° C. or more preferably by 10 to 40° C. This heating increases the particle diameter D_{L} of the silica sol. Increase in a particle diameter D_{L} may be due to contact and binding among colloidal silica particles. Meanwhile, a particle diameter D_{B} is hardly increased in (e). This is because growth of a particle diameter D_{B} depends on the heating temperature and the heating time in (c) in which the heating temperature is higher than that in (e). When heating in (e) is performed at a temperature that is the same as or higher than that in (c), there is a case in which a particle diameter D_{B} is increased and, at the same time, a particle diameter D_{L} is sharply increased. This may make control of the particle diameter D_{L} difficult and cause gelation of the silica sol. This step (e) is a process in which the growth of a particle diameter D_{L} is controlled while completely or almost completely preventing a particle diameter D_{B} from growing.

The above-mentioned (a), (b), (c), (d), and (e) provides an elongated-shaped silica sol in which colloidal silica particles are dispersed stably in a liquid medium. In the colloidal silica particles, a particle diameter (D_{B2} nm) of colloidal silica particles obtained through (e) determined by the nitrogen adsorption method is 5 to 20 nm. In addition, the ratio of the particle diameters (D_{L2}/D_{B2}) of the particle diameter (D_{B2} nm) and a particle diameter (D_{L2} nm) of the above colloidal silica particles determined by the dynamic light scattering is 4 to 20. A particle diameter (D_{B1} nm) of colloidal silica particles obtained through (c) determined by the nitrogen adsorption method, a particle diameter (D_{L1} nm) of colloidal silica particles obtained through (c) determined by the dynamic light scattering, a particle diameter (D_{B2} nm) of colloidal silica particles obtained through (e) determined by the nitrogen adsorption method, and a particle diameter (D_{L2} nm) of colloidal silica particles obtained through (e) determined by the dynamic light scattering satisfy the relationship represented by the following formula (I):

(D_{L2}/D_{B2})/(D_{L1}/D_{B1})≧1.2 (I).

The silica sol obtained by a method of the present invention including (a), (b), (c), (d), and (e) is a basic aqueous silica sol, and by subjecting the silica sol to a cation exchange treatment, an acidic aqueous silica sol generally with a pH of 2 to 4 can be obtained. Substitution of water that is a dispersion medium of the acidic aqueous silica sol, with an organic solvent by a typical method such as distillation exchange provides an organic solvent-dispersed silica sol. The dispersion medium of this organic solvent-dispersed silica sol includes, for example, alcohols such as methanol, ethanol, isopropanol, and butanol; multivalent alcohols such as ethylene glycol; ethers such as dimethyl ether, and ethylene glycol monomethyl ether; ketones such as methyl ethyl ketone, and methyl isobutyl ketone; hydrocarbons such as toluene and xylene; and amides such as dimethylacetamide, and dimethyl formamide.

### EXAMPLES

An analytical method for a chemical composition and a method for determining physical properties in Examples and Comparative Examples are as follows:

1) pH

Determination was performed by an ion electrode method at room temperature.

2) SiO₂ concentration

Determination was performed by a mass method.

3) Anion (Cl⁻, NO₃⁻, and SO₄²⁻) concentration

Water filtered from aqueous silica sol by using an ultrafiltration having a molecular weight cut-off of 10,000 was analyzed by using high performance liquid ion chromatography (IC25; manufactured by DIONEX Corporation; column: InoPac AS17; eluting solution: 0.15 mM potassium hydroxide).

4) Particle diameters D_{L1} and D_{L2} (particle diameter measured by using the dynamic light scattering)

Determination was performed by using a dynamic light scattering instrument (submicron particle analyzer model N4; manufactured by Beckman Coulter, Inc.)

5) Particle diameters D_{B1} and D_{B2} (particle diameter measured by using a nitrogen adsorption method)

After sodium adsorbed on the surface of a silica sol was removed by making a hydrogen-type strong acid cation exchange resin contact with an aqueous silica sol, powder sample was prepared by drying at 300° C. followed by milling the sample. Particle diameters D_{B1} and D_{B2} (nm) of the prepared powder sample were obtained by determining specific surface areas S (m²/g) by a BET method with a nitrogen adsorption specific surface area meter (Monosorb MS-16; manufactured by Yuasa Ionics Inc.).

As a calculating formula, the following equation (II):

D_{B}(nm)=2720/S(m²/g) (II)

in which colloidal silica particles are obtained as a spherical particle was used.

6) Electron microscope observation

An image of particles was taken by using a transmission electron microscope (JEM-1010; manufactured by JEOL Ltd.) at an accelerating voltage of 100 kV.

### Example 1

To commercially available sodium water glass (JIS No. 3 sodium water glass: a SiO₂ concentration of 28.8% by mass and a Na₂O concentration of 9.47% by mass), water was added to obtain a sodium silicate aqueous solution with a SiO₂ concentration of 3.8% by mass. An aqueous colloidal solution of active silicic acid with a SiO₂ concentration of 3.6% by mass and pH of 2.9 was obtained by passing this sodium silicate aqueous solution through a column filled with hydrogen-type strong acid cation exchange resin (Amberlite IR-120B; manufactured by Rohm and Haas Company). To this aqueous colloidal solution of active silicic acid, a 10% by mass calcium nitrate aqueous solution was added with stirring at 20° C. in an amount in which CaO is contained at 5500 mass ppm relative to SiO₂. After 30 minutes, a 10% by mass sodium hydroxide aqueous solution was further added in an amount in which a SiO₂/Na₂O molar ratio is 80, thereafter the concentration was adjusted with pure water so that a SiO₂ concentration in the colloidal aqueous solution is 3% by mass. Then, 2800 g of a concentration-adjusted aqueous colloidal solution was put into a stainless-steel (SUS) autoclave with an internal space of 3 L and equipped with a stirrer and a thermometer, and heated at 130° C. with stirring for 6 hours. After that, a silica sol was cooled to 25° C. and took out. The obtained silica sol had an anion concentration of 1.38% by mass to SiO₂. Anions and water were partially removed by concentrating the silica sol by using an ultrafiltration device (a molecular weight cut-off of 50,000). The obtained silica sol had the following physical properties: a specific gravity: 1.130; pH 9.3; electric conductance: 2320 μS/cm; type B viscosity: 7.2 mPa·s; SiO₂ concentration: 20% by mass; and anion concentration: 0.16% by mass to SiO₂. A particle diameter D_{L1} was 32.4 nm, a particle diameter D_{B1} was 9.8 nm, and, therefore, D_{L1}/D_{B1}=3.3. Then, 2800 g of the silica sol obtained through this ultrafiltration was put into a stainless-steel autoclave with an internal space of 3 L and heated at 105° C. with stirring for 8 hours. The obtained silica sol had the following physical properties: specific gravity: 1.130; pH 9.6; electric conductance: 2290 μS/cm; type B viscosity: 19.8 mPa·s; particle diameter D_{L2}: 52.8 nm; and particle diameter D_{B2}: 10.5 mm. Therefore, D_{L2}/D_{B2}=5.0, and (D_{L2}/D_{B2})/(D_{L1}/D_{B1})=1.5.

### Example 2

Into a glass reaction container with an internal space of 1 L, equipped with a stirrer, a reflux apparatus, and a thermometer, 800 g of the silica sol obtained after the ultrafiltration in Example 1 (a SiO₂ concentration of 20% by mass, an anion concentration of 0.16% by mass to SiO₂, a particle diameter D_{L1} of 32.4 nm, and a particle diameter D_{B1} of 9.8 nm) was put and then heated at 100° C. with stirring for 8 hours. The obtained silica sol had the following physical properties: specific gravity: 1.130; pH 10.3; electric conductance: 2300 μS/cm; type B viscosity: 22.5 mPa·s; SiO₂ concentration: 20% by mass; anion concentration: 0.16% by mass to SiO₂; particle diameter D_{L2}: 58.0 nm; particle diameter D_{B2}: 10.0 nm. Therefore, D_{L2}/D_{B2}=5.8, and (D_{L2}/D_{B2})/(D_{L1}/D_{B1})=1.8.

### Example 3

The silica sol obtained after the ultrafiltration in Example 1 (a SiO₂ concentration of 20% by mass, an anion concentration of 0.16% by mass to SiO₂, a particle diameter D_{L1} of 32.4 nm, and a particle diameter D_{B1} of 9.8 nm) was condensed by removing part of water to a SiO₂ concentration of 30% by mass with a rotary evaporator under the conditions of 60 mmHg and a bath temperature of 60° C. for 1 hour. The silica sol had a temperature of 32° C. at this time. Into a glass reaction container with an internal space of 1 L, equipped with a stirrer, a reflux apparatus, and a thermometer, 800 g of the condensed silica sol was put and then heated at 80° C. for 5 hours with stirring. The obtained silica sol had the following properties: specific gravity: 1.204; pH 10.2; electric conductance: 3629 ES/cm; type B viscosity: 600 mPa·s; SiO₂ concentration: 30% by mass; and anion concentration: 0.16% by mass to SiO₂; particle diameter D_{L2}: 50.2 nm; and particle diameter D_{B2}: 10.0 nm. Therefore, D_{L2}/D_{B2}=5.0, and (D_{L2}/D_{B2})/(D_{L1}/D_{B1})=1.5.

### Comparative Example 1

The silica sol obtained after the ultrafiltration in Example 1 (a SiO₂ concentration of 20% by mass, an anion concentration of 0.16% by mass to SiO₂, a particle diameter. D_{L1} of 32.4 nm, and a particle diameter D_{B1} of 9.8 nm) was condensed by removing part of water to a SiO₂ concentration of 30% by mass with a rotary evaporator under the conditions of 60 mmHg and a bath temperature of 60° C. for 1 hour. The silica sol had a temperature of 32° C. at this time. Into a glass reaction container with an internal space of 1 L, equipped with a stirrer, a reflux apparatus, and a thermometer, 800 g of the condensed silica sol was put and heated at 60° C. for 8 hours. The obtained silica sol had a particle diameter D_{L2} of 32.4 nm and a particle diameter D_{B2} of 10.0 nm, showing no change in the particle diameter D_{L2}. Therefore, D_{L2}/D_{B2}=3.2, and (D_{L2}/D_{B2})/(D_{L1}/D_{B1})=1.0.

### Comparative Example 2

Without removing water or anions from the silica sol obtained after heating at 130° C. for 6 hours in Example 1 (a SiO₂ concentration of 3% by mass, a particle diameter D_{L1} of 32.4 nm, and a particle diameter D_{B1} of 9.8 nm), the silica sol with a SiO₂ concentration of 3% by mass was charged in the same autoclave as that in Example 1 and heated at 105° C. for 8 hours with stirring. The obtained silica sol had the following properties: specific gravity: 1.012; pH 9.3; electric conductance: 700 μS/cm; type B viscosity: 4.0 mPa·s; particle diameter D_{L2}: 32.4 nm; and particle diameter D_{B2}, 10.0 nm, showing no change in the particle diameter D_{L2}. Therefore, D_{L2}/D_{B2}=3.2, and (D_{L2}/D_{B2})/(D_{L1}/D_{B1})=1-0

### Comparative Example 3

The silica sol obtained after heating at 130° C. for 6 hours in Example 1 (a SiO₂ concentration of 3% by mass, a particle diameter D_{L1} of 32.4 nm, and a particle diameter D_{B1} of 9.8 nm) was condensed by removing part of water to a SiO₂ concentration of 20% by mass with a rotary evaporator under the conditions of 60 mmHg and a bath temperature of 60° C. for 40 minutes. The silica sol had a temperature of 32° C. at this time. No anion was removed during the condensation. After the condensation, an anion concentration in silica sol was 1.38% by mass to SiO₂. Into a glass reaction container with an internal space of 1 L, equipped with a stirrer, a reflux apparatus, and a thermometer, 800 g of the condensed silica sol was put and heated with stirring and was then turned into gel-like substance showing no fluidity when the temperature of the silica sol reached 90° C. Thus, no silica sol was obtained.

### Comparative Example 4

Into a 3-L autoclave similar to that in Example 1, 2500 g of the silica sol obtained after the ultrafiltration in Example 1 (a SiO₂ concentration of 20% by mass, an anion concentration of 0.16% by mass to SiO₂, a particle diameter D_{L1} of 32.4 nm, and a particle diameter D_{B1} of 9.8 nm) was put and then heated at 130° C. with stirring for 1 hour. Subsequently, the sol was turned into gel-like substance showing no fluidity. Thus, no silica sol was obtained.

### Comparative Example 5

Similarly to Example 1, a 10% by mass calcium nitrate aqueous solution was added to an aqueous colloidal solution of active silicic acid in an amount in which CaO is contained at 5500 mass ppm relative to SiO₂. After 30 minutes, a 10% by mass sodium hydroxide aqueous solution was further added in an amount in which a SiO₂/Na₂O molar ratio is 80, and then pure water was added so that a SiO₂ concentration in the aqueous colloidal solution becomes 3% by mass. Then, 2800 g of the aqueous colloidal solution was charged into the same autoclave as that in Example 1 and heated at 130° C. with stirring for 25 hours. The obtained silica sol had the following physical properties: specific gravity: 1.130; pH 9.4; electric conductance: 2300 μS/cm; type B viscosity: 8.0 mPa·s; particle diameter D_{L2}: 47.9 nm; and particle diameter D_{B2}: 12.5 nm. Therefore, D_{L2}/D_{B2}=3.8, indicating D_{L2}/D_{B2}≦4.

### Example 4

To an aqueous colloidal solution of active silicic acid obtained in a similar manner to Example 1, a 10% by mass calcium nitrate aqueous solution was added in an amount in which CaO is contained at 6700 mass ppm relative to SiO₂, then a 10% by mass sodium hydroxide aqueous solution was added in an mount that a SiO₂/Na₂O molar ratio is 60. Subsequently, pure water was further added so that a SiO₂ concentration becomes 3% by mass. Then, 2800 g of the aqueous colloidal solution was charged into a SUS autoclave with an internal space of 3 L and heated at 128° C. with stirring for 2.5 hours and, after that, cooled to room temperature to take out the silica sol. The obtained silica sol had an anion concentration of 1.71% by mass to SiO₂. Anions and water were partially removed by concentrating the silica sol at 25° C. by using an ultrafiltration device (a molecular weight cut-off of 50,000). The obtained silica sol had the following physical properties: specific gravity: 1.130; pH 9.5; electric conductance: 2420 μS/cm; type B viscosity: 8.2 mPa·s; SiO₂ concentration, 20% by mass; anion concentration to SiO₂: 0.25% by mass; particle diameter D_{L1}: 31.8 nm; particle diameter D_{B1}: 8.7 nm; and therefore, D_{L1}/D_{B1}=3.7. Into a glass reaction container with an internal space of 1 L, equipped with a stirrer, a reflux apparatus, and a thermometer, 800 g of the silica sol obtained after this ultrafiltration was put and then heated at 98° C. with stirring for 8 hours. The obtained silica sol had the following physical properties: specific gravity: 1.130; pH 9.6; electric conductance; 2290 μS/cm; type B viscosity: 19.8 mPa·s; particle diameter D_{L2}: 52.9 nm; and particle diameter D_{B2}: 9.5 nm. Therefore, D_{L2}/D_{B2}=5.6, and (D_{L2}/D_{B2})/(D_{L1}/D_{B1})=1.5.

### Example 5

Into a SUS autoclave with an internal space of 3 L, 2500 g of the silica sol obtained after the ultrafiltration in Example 4 (a SiO₂ concentration of 20% by mass, an anion concentration of 0.25% by mass to SiO₂, a particle diameter D_{L1} of 31.8 mm, and a particle diameter D_{B1} of 8.7 nm) was put and then heated at 110° C. with stirring for 2 hours. The obtained silica sol had the following physical properties: specific gravity: 1.130; pH 10.3; electric conductance: 2260 μS/cm; type B viscosity: 41.8 mPa·s; particle diameter D_{L2}: 63.0 nm; and particle diameter D_{B2}: 10.3 nm. Therefore, D_{L2}/D_{B2}=6.1, and (D_{L2}/D_{B2})/(D_{L1}/D_{B1})=1.7.

### Example 6

To an aqueous colloidal solution of active silicic acid obtained in a similar manner to Example 1, a 10% by mass calcium nitrate aqueous solution was added in an amount in which CaO is contained at 5700 mass ppm relative to SiO₂, then a 10% by mass sodium hydroxide aqueous solution was added in an amount in which a SiO₂/Na₂O molar ratio is 70, and thereafter pure water was further added to achieve a SiO₂ concentration of 3% by mass. Then, 2800 g of the aqueous colloidal solution was put into a SUS autoclave with an internal space of 3 L and then heated at 128° C. with stirring for 4.5 hours to obtain a silica sol. The obtained silica sol had an anion concentration of 1.46% by mass to SiO₂. Anions and water were partially removed, by concentrating the silica sol at 25° C. by using an ultrafiltration device (a molecular weight cut-off of 50,000). The obtained silica sol had the following physical properties: specific gravity: 1.130; pH 10.2; electric conductance: 2320 μS/cm; type B viscosity: 9.8 mPa·s; SiO₂ concentration: 20% by mass; anion concentration to SiO₂: 0.24% by mass; particle diameter D_{L1}: 38.8 nm; particle diameter D_{B1}: 10.2 nm; and therefore, D_{L1}/D_{B1}=3.8. Into a SUS autoclave with an internal space of 3 L, 2500 g of the silica sol obtained after this ultrafiltration was put and then heated at 105° C. with stirring for 7 hours. The obtained silica sol had the following physical properties: specific gravity: 1.130; pH 10.3; electric conductance: 2260 μS/cm; type B viscosity: 41.8 mPa·s; particle diameter D_{L2}: 63.3 nm; and particle diameter D_{B2}: 10.5 nm. Therefore, D_{L2}/D_{B2}=6.0, and (D_{L2}/D_{B2})/(D_{L1}/D_{B1})=1.6.

### Example 7

To an aqueous colloidal solution of active silicic acid obtained in a similar manner to Example 1, a 10% by mass calcium nitrate aqueous solution was added in an amount in which CaO is contained at 5700 mass ppm relative to SiO₂, then a 10% by mass sodium hydroxide aqueous solution was added in an amount in which a SiO₂/Na₂O molar ratio is 70, and thereafter pure water was further added to achieve a SiO₂ concentration of 3% by mass. Then, 2800 g of the aqueous colloidal solution was put into a SUS autoclave with an internal space of 3 L and heated at 128° C. with stirring for 5.6 hours to obtain a silica sol. The obtained silica sol had an anion concentration of 1.46% by mass to SiO₂. Anions and water were partially removed, by concentrating the silica sol at 25° C. by using an ultrafiltration device. The obtained silica sol had the following physical properties: specific gravity: 1.092; pH 10.9; electric conductance: 2450 ES/cm; type B viscosity: 8.0 mPa·s; SiO₂ concentration: 15% by mass; anion concentration: 0.39% by mass to SiO₂; particle diameter D_{L1}: 48.0 nm; particle diameter D_{B1}: 9.6 nm; and D_{L1}/D_{B1}=5. Into a glass reaction container with an internal space of 1 L, equipped with a stirrer, a reflux apparatus, and a thermometer, 800 g of the silica sol obtained after this ultrafiltration was put and then heated at 98° C. with stirring for 7 hours. The obtained silica sol had the following physical properties: specific gravity: 1.092; pH 10.4; electric conductance: 2420 μS/cm; type B viscosity: 23.5 mPa·s; particle diameter D_{L2}: 75.8 nm; and particle diameter D_{B2}: 9.7 nm. Therefore, D_{L2}/D_{B2}=7.8, and (D_{L2}/D_{B2})/(D_{L1}/D_{B1})=1.6.

### Example 8

To an aqueous colloidal solution of active silicic acid obtained in a similar manner to Example 1, a 10% by mass calcium nitrate aqueous solution was added in an amount in which CaO is contained at 6000 mass ppm relative to SiO₂, then a 10% by mass sodium hydroxide aqueous solution was added in an amount in which a SiO₂/Na₂O molar ratio is 50, and then pure water was further added to achieve a SiO₂ concentration of 3% by mass. Then, 2800 g of the aqueous colloidal solution was put into a SUS autoclave with an internal space of 3 L and heated at 140° C. with stirring for 12 hours to obtain a silica sol. The obtained silica sol had an anion concentration of 1.54% by mass to SiO₂. Anions and water were partially removed by concentrating the silica sol at 25° C. by using an ultrafiltration device. The obtained silica sol had the following physical properties: specific gravity: 1.130; pH 10.3; electric conductance: 2450 μS/cm; type B viscosity: 8.6 mPa·s; SiO₂ concentration: 20% by mass; anion concentration to SiO₂: 0.30% by mass; particle diameter D_{L1}: 47 nm; particle diameter D_{B1}: 12.2 nm; and D_{L1}/D_{B1}=3.9. Into an autoclave with an internal space of 3 L, 2500 g of the silica sol obtained after this ultrafiltration was put and heated at 103° C. with stirring for 3.5 hours. The obtained silica sol had the following physical properties: specific gravity: 1.130; pH 10.3; electric conductance: 2400 μS/cm; type B viscosity: 11.3 mPa·s; particle diameter D_{L2}: 61.7 nm; and particle diameter D_{B2}: 12.2 nm. Therefore, D_{L2}/D_{B2}=5.1, and (D_{L2}/D_{B2})/(D_{L1}/D_{B1})=1.3.

### Example 9

Into a SUS autoclave with an internal space of 3 L, 2800 g of the silica sol obtained after the ultrafiltration in Example 8 (a SiO₂ concentration of 20% by mass, an anion concentration of 0.30% by mass to SiO₂, a particle diameter D_{L1} of 47 nm, and a particle diameter D_{B1} of 12.2 nm) was put and heated at 103° C. with stirring for 9 hours. The obtained silica sol had the following physical properties: specific gravity: 1.130; pH 10.3; electric conductance: 2400 μS/cm; type B viscosity: 14.4 mPa·s; particle diameter D_{L2}: 71.1 nm; and particle diameter D_{B2}: 12.2 nm. Therefore, D_{L2}/D_{B2}=5.8, and (D_{L2}/D_{B2})/(D_{L1}/D_{B1})=1.5.

### Example 10

To an aqueous colloidal solution of active silicic acid obtained in a similar manner to Example 1, 10% by mass calcium nitrate aqueous solution was added in an amount in which CaO is contained at 8330 mass ppm relative to SiO₂, then a 10% by mass sodium hydroxide aqueous solution was added in an amount in which a SiO₂/Na₂O molar ratio is 60, and then pure water was further added to achieve a SiO₂ concentration of 3% by mass. Then, 2800 g of the aqueous colloidal solution was put into a SUS autoclave with an internal space of 3 L and heated at 110° C. with stirring for 3 hours to obtain a silica sol. The obtained silica sol had an anion concentration of 2.11% by mass. Anions and water were partially removed by concentrating the silica sol at 25° C. by using an ultrafiltration device. The obtained silica sol had the following physical properties: specific gravity: 1.092; pH 9.3; electric conductance: 2040 μS/cm; type B viscosity: 13.3 mPa·s; SiO₂ concentration: 15% by mass; anion concentration to SiO₂: 0.58% by mass; particle diameter D_{L1}: 45.8 nm; particle diameter D_{B1}: 7.9 mm; and D_{L1}/D_{B1}=5.8. Into a glass reaction container with an internal space of 1 L, equipped with a stirrer, a reflux apparatus, and a thermometer, 800 g of the silica sol obtained after this ultrafiltration was put and then heated at 90° C. with stirring for 1.5 hours. The obtained silica sol had the following physical properties: specific gravity: 1.092; pH 9.3; electric conductance: 2040 μS/cm; type B viscosity: 135 mPa·s; particle diameter D_{L2}: 73.4 nm; and particle diameter D_{B2}: 8.0 nm. Therefore, D_{L2}/D_{B2}=9.2, and (D_{L2}/D_{B2})/(D_{L1}/D_{B1})=1.6.

### INDUSTRIAL APPLICABILITY

The present invention is characterized in that both particle diameter D_{L} and particle diameter D_{B} can easily be controlled through two processes including one to control particle diameter D_{B} and the other to control particle diameter D_{L} in producing an elongated-shaped silica sol. The elongated-shaped silica sol obtained by a method of the present invention shows an excellent coating property due to the shape when being dried on a solid surface, and is effectively used for a pigment and in other various fields.

### BRIEF DESCRIPTION OF THE DRAWINGS

FIG. 1 is a transmission electron microscopic image of a silica sol after heating in (c) at 128° C. in Example 4 (particle diameter D_{L1}: 31.8 nm; particle diameter D_{B1}: 8.7 nm; and D_{L1}/D_{B1}: 3.7).

FIG. 2 is a transmission electron microscopic image of a silica sol after heating in (e) at 98° C. in Example 4 (particle diameter D_{L2}: 52.9 nm; particle diameter D_{B2}: 9.5 nm; and D_{L2}/D_{B2}: 5.6).

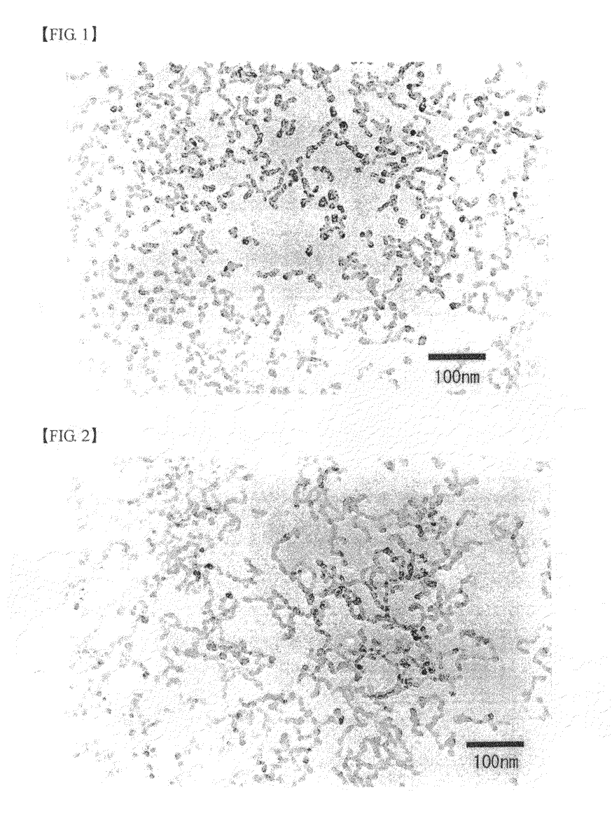

1. A method for producing an elongated-shaped silica sol comprising the following (a), (b), (c), (d), and (e); wherein a particle diameter (D_{B2} nm) of colloidal silica particles obtained through (e) determined by a nitrogen adsorption method is 5 to 20 nm, a ratio of particle diameters (D_{L2}/D_{B2}) of the particle diameter (D_{B2} nm) and a particle diameter (D_{L2} nm) of the colloidal silica particles determined by dynamic light scattering is 4 to 20, and a particle diameter (D_{B1} nm) of colloidal silica particles obtained through (c) determined by the nitrogen adsorption method and a particle diameter (D_{L1} nm) of colloidal silica particles obtained through (c) determined by the dynamic light scattering as well as the particle diameter (D_{B2} nm) of colloidal silica particles obtained through (e) determined by the nitrogen adsorption method, and the particle diameter (D_{L2} nm) of colloidal silica particles obtained through (e) determined by the dynamic light scattering satisfy the relationship represented by the following formula (I):
(D_{L2}/D_{B2})/(D_{L1}/D_{B1})≧1.2 (I);
(a) adding an aqueous solution containing a water soluble calcium salt, magnesium salt, or a mixture of the water soluble calcium salt and magnesium salt to an aqueous colloidal solution of active silicic acid with an SiO₂ concentration of 1 to 6% by mass and a pH of 2 to 5 in a mass ratio of CaO, MgO, or both of CaO and MgO to SiO₂ in the active silicic acid of 1500 to 15,000 ppm, and mixing;
(b) adding alkali metal hydroxide, a water soluble organic base, or water soluble silicate of the alkali metal hydroxide or the water soluble organic base to an aqueous solution obtained through (a) in a molar ratio converted by a formula represented by SiO₂/M₂O (where SiO₂ represents a total content of a silica content derived from the active silicic acid and a silica content in the water soluble silicate, and M represents the alkali metal atom or the organic base molecule) of 20 to 200, and mixing;
(c) heating a mixture obtained through (b) at 85 to 200° C. for 0.5 to 20 hours so as to obtain a colloidal solution;
(d) removing, from the colloidal solution obtained through (c), part of water and at least part of anions derived from the aqueous solution containing the water soluble calcium salt, magnesium salt, or the mixture of the water soluble calcium salt and magnesium salt; and
(e) heating a colloidal solution obtained through (d) at a temperature of 80 to 195° C. that is lower than a heating temperature in (c) for 0.5 to 20 hours.

2. The method for producing an elongated-shaped silica sol according to claim 1, wherein heating in (e) is performed at a temperature lower by 5 to 60° C. than the heating temperature in (c).

3. The method for producing an elongated-shaped silica sol according to claim 1, wherein removal of anions in (d) is performed until the amount of anions in the colloidal solution becomes 1.0% by mass or less to the amount of SiO₂ contained in the colloidal solution.

4. The method for producing an elongated-shaped silica sol according to claim 1, wherein removal of water in (d) is performed until the concentration of SiO₂ in the colloidal solution becomes 10 to 40% by mass.
